(19) United States
(12) Patent Application Publication
(10) Pub. No.: US 2021/0192636 A1
(43) Pub. Date: Jun. 24, 2021

(54) Computing Vehicle Insurance Charges

(71) Applicant: By Miles Ltd., London (GB)

(72) Inventors: James Blackham, London (GB); Callum Rimmer, London (GB)

(73) Assignee: By Miles Ltd., London (GB)

(21) Appl. No.: 17/032,970

(22) Filed: Sep. 25, 2020

Related U.S. Application Data
(60) Provisional application No. 62/952,910, filed on Dec. 23, 2019.

(51) Int. Cl. G06Q 40/08; G06Q 30/02; G07C 5/08; G07C 5/00

(52) U.S. Cl. CPC G06Q 40/08; G07C 5/008; G07C 5/0808; G06Q 30/0284

(57) ABSTRACT

A system for determining a motor vehicle insurance charge for a journey comprises an insurance provider server in communication with at least one vehicle server configured to store vehicle journey data from a vehicle. The insurance provider server comprises a memory; a communication module for receiving the vehicle journey data for the vehicle from the at least one vehicle server, the vehicle journey data comprising odometer data and vehicle sensor data acquired over the course of the journey; a distance processing module for analyzing the received odometer data to determine the distance travelled by the vehicle in the journey; a risk processing module for analyzing the vehicle sensor data to determine one or more risk factors associated with the journey; a pricing module for computing an insurance charge; and a charging module for processing the insurance charge for one or more journeys to compute an insurance premium and collect payment.

### CROSS-REFERENCE TO RELATED APPLICATIONS

This application claims priority to U.S. Provisional Application No. 62/952,910, filed Dec. 23, 2019, entitled “Method of Computing Vehicle Insurance Charges,” the disclosure of which is hereby incorporated by reference.

### FIELD

The present disclosure relates to a method of computing vehicle insurance charges for a journey. More specifically, it relates to computing the insurance charges based on distance travelled and level of risk associated with the journey.

### BACKGROUND

Travelling by road is the most common way to reach from one place to another. It is often mandatory or preferred to have an insurance in place when driving a vehicle to provide cover for any accidents or other unforeseen incidents during a road journey. Typically, a driver or an owner of a vehicle is the named policyholder on an insurance policy and is expected to pay an annual charge (known as insurance premium) for the cover. The annual charge is often based on static factors such as driver's driving record, age, life of vehicle, etc. The annual charge may change year on year based on these or other factors. The driver has little control on the charges and is bound to pay the same fixed amount irrespective of his or her vehicle usage.

To overcome this issue, some insurance providers now offer insurance where each journey is paid instead of charging a fixed amount annually. This is especially valid for car rentals where the driver only hires a car for a set period of time and is accordingly charged for that duration. While such journey-based insurance cover may be cheaper for occasional drivers, it is still based on the static factors as above and distance travelled, but does not account for other dynamic factors that may affect the journey. As each journey is different, computing insurance charges based on such limited information may not be ideal. Moreover, distance reading obtained visually from the odometer of the vehicle after the completion of the journey may not be accurate as the odometer or visual representation of it may be tampered with.

### SUMMARY

There is a need to provide a method of computing insurance charges which are reflective of the journey taken and are based on objective and transparent parameters.

According to an aspect of the present disclosure, there is provided a system for determining a motor vehicle insurance charge for a journey, comprising an insurance provider server in communication with at least one vehicle server configured to store vehicle journey data received from a first vehicle, wherein the insurance provider server comprises a memory; a communication module for receiving the vehicle journey data for the first vehicle from the at least one vehicle server, the vehicle journey data comprising odometer data and vehicle sensor data acquired by the at least one vehicle server from one or more sensors on the first vehicle over the course of the journey; a distance processing module for analyzing the received odometer data to determine the distance travelled by the first vehicle in the journey; a risk processing module for analyzing the vehicle sensor data to determine one or more risk factors associated with the journey; a pricing module for computing an insurance charge based at least on the distance travelled and the one or more risk factors for the journey; and a charging module for processing the insurance charge for one or more journeys to compute an insurance premium and collect payment from an owner or driver of the first vehicle.

Advantageously, computing insurance charges based on distance and sensor data directly obtained from a vehicle server increases the accuracy and reliability. Moreover, assessing the risk of a journey based on the sensor data also allows the charges to reflect the cost associated with risk.

In some implementations, the communication module further receives a vehicle software version from the vehicle server, the vehicle software version being indicative of performance of one or more components of the first vehicle.

In some implementations, the insurance charge is further based on the vehicle software version.

In some implementations, the one or more sensors on the first vehicle collect information relating to one or more of fuel level, fuel/energy consumption, outside temperature, inside temperature, tire pressure, engine oil level, engine oil pressure, anti-lock braking, traction control, stability control, cruise control, airbags, washer fluid level, windscreen wiper, audio/video system, outside precipitation, fog light, headlight, number of passengers, seat belt buckle status, speed, RPM, indicator lights, pressure on brake and accelerator pedals, windows, convertible/panoramic roof state, vehicle battery level, maintenance data, fault codes, ignition state, autonomous driving state, gear data, time of the day, and GPS position of the vehicle.

In some implementations, the insurance provider server is configured to obtain a permission from the owner or driver of the first vehicle to receive the vehicle journey data from the at least one vehicle server.

In some implementations, the insurance provider server is configured to obtain the permission from the owner or driver of the first vehicle using a mobile application.

In some implementations, the insurance provider server is to receive the vehicle journey data from the at least one vehicle server via an intermediary.

In some implementations, the intermediary is configured to collate data from vehicle servers of a plurality of vehicle manufacturers in a standardized format.

In some implementations, the intermediary is configured to receive the vehicle journey data at periodic intervals.

In some implementations, the vehicle servers are configured to send the vehicle journey data to the intermediary immediately after processing the odometer data and the sensor data received from one or more vehicles.

According to another aspect of the disclosure, there is provided a computer-implemented method of determining a motor vehicle insurance charge for a journey, comprising the steps of receiving vehicle journey data for a first vehicle from the at least one vehicle server, the vehicle journey data comprising odometer data and vehicle sensor data acquired by the at least one vehicle server from one or more sensors on the first vehicle over the course of the journey; analyzing the received odometer data to determine the distance travelled by the first vehicle in the journey; analyzing the vehicle sensor data to determine one or more risk factors associated with the journey; computing an insurance charge based at least on the distance travelled and the one or more risk factors for the journey; and processing the insurance charge for one or more journeys to compute an insurance premium and to collect payment for the one or more journeys.

In some implementations, the vehicle software version is indicative of the performance of one or more components of the vehicle.

In some implementations, the insurance charge is based on the vehicle software version.

In some implementations, the method further includes receiving the vehicle journey data through an intermediary which is connected to a plurality of vehicle servers operated by respective plurality of vehicle manufacturers.

In some implementations, the method further includes collating the vehicle journey data in a standardized format by the intermediary before sending it to an insurance provider server.

### BRIEF DESCRIPTION OF THE DRAWINGS

Embodiments of the present disclosure are described below, by way of example only, with reference to the accompanying drawings, in which:

FIG. 1 is a schematic of a system comprising an insurance provider server and various inter-connected entities;

FIG. 2 is a block diagram of modules contained in the insurance provider server of FIG. 1; and

FIG. 3 is a flow diagram of a method for calculating insurance charges for a journey according to an aspect of the disclosure.

### DETAILED DESCRIPTION

Next, various aspects will be described. In the following description, unless specified otherwise, terms take their usual meaning. Note that the same or similar entities are denoted with the same or similar reference signs in the description of the drawings below.

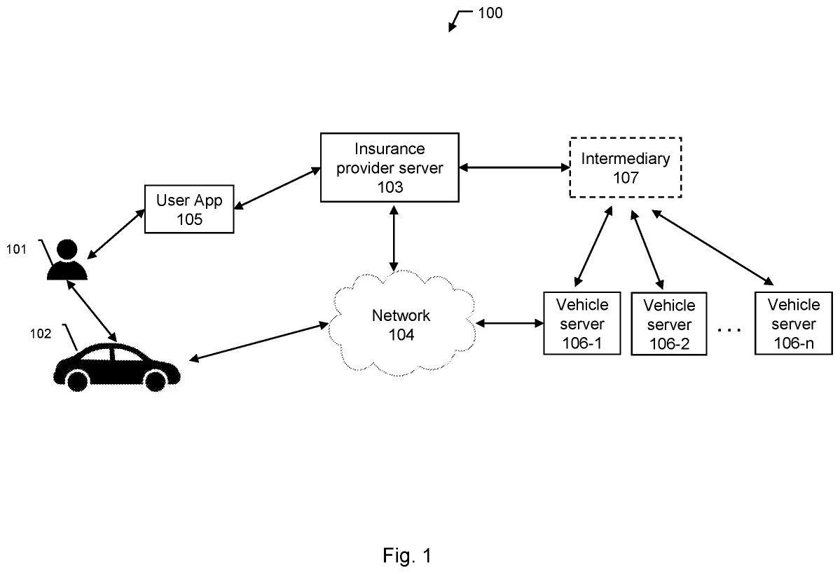

As shown in FIG. 1, system 100 comprises a driver 101 and a vehicle 102 associated with the driver 101. The driver 101 may or may not be the owner of the vehicle 102, but is the primary user of the vehicle 102 over the course of a journey. The vehicle 102 in the present example is a car but can be any other road vehicle such as van, truck, or motor bike. The system 100 also comprises an insurance provider server 103, which is a remote server preferably hosted and managed by an insurance service provider (not shown) or by a trusted third party on behalf of the insurance service provider. The insurance provider server 103 is referred to as insurance server 103 hereinafter for the sake of simplicity. The insurance server 103 is connected to a network 104 which is typically a public network such as the internet. The insurance server 103 is also connected to the driver 101 via a user App 105 which is preferably installed on a user personal computing device (not shown) owned by the driver 101. The user personal computing device can any device that runs an operating system compatible with the user App 105, such as a smartphone, laptop or in-car infotainment system.

The user App 105 is a user-friendly application preferably managed by the insurance service provider and communicably connected to the insurance server 103 via the network 104. The user App 105 enables the driver 101 and the insurance server 103 to interact with each other and exchange data such as driver details, insurance provider details, insurance charges, etc.

The system 100 further comprises a plurality of vehicle servers 106-1 to 106-n, collectively referred to as vehicle servers 106. The vehicle servers 106 are remote servers associated with respective vehicle manufacturers and configured to communicate with the vehicles such as vehicle 102 via the network 104. For example, the vehicle 102 is a car manufactured by a vehicle manufacturer, such as Ford™ or Honda™, which also manages the vehicle server 106-1 to remotely monitor the performance of the car, perform routine health checks and maintenance and provide the car owner information about the vehicle. The vehicle server 106-1 may also be able to interact with the driver 101 via an in-built user interface system in the dashboard of the vehicle 102 or through an associated App, similar to the user App 105.

The vehicle servers 106 are connected to the insurance server 103 either directly or via an intermediary 107. The insurance server 103 receives information about the vehicle 102 as well other vehicles via the vehicle servers 106 over the network 104 or preferably via a private secure network. The insurance server 103 processes the information received from the vehicle server 106 to calculate insurance charges for the customers of the insurance service provider.

The intermediary 107 is a third party provider which is configured to collect data from the vehicle servers 106 on behalf of the insurance server 103 as well as servers of other similar insurance providers. As the data received from the vehicle servers 106 operated by different vehicle manufacturers may not be the same format, the intermediary 107 collates the data in a standardised format before sending it to the insurance server 103 for easy further processing. Depending on access policies and controls imposed on the vehicle servers 106 by their respective vehicle manufacturers, the insurance server 103 may be able to connect to some of the vehicle servers 106 directly and to others indirectly via the intermediary 107. The intermediary 107 may provide a monitoring device to be placed in the vehicle 102 and connected to a remote server managed by the intermediary 107. It is to be noted that the insurance server 103 and the intermediary 107 are preferably connected to each other via a secure connection, either wired or wireless.

It will be appreciated that while the system 100 only shows one user, one vehicle, and one insurance server 103 for the sake of simplicity, the system 100 also comprises other users, vehicles, and insurance servers. Moreover, the system 100 may also include other entities such as vehicle rental companies which may engage with the insurance provider and charge the driver 101 later.

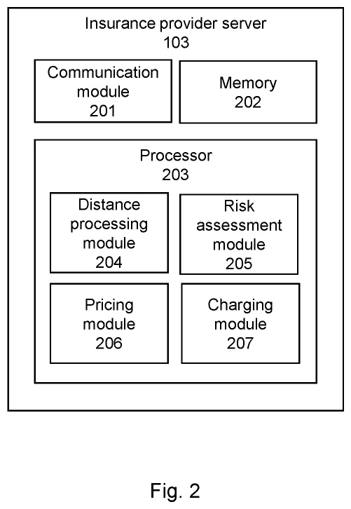

FIG. 2 shows various modules of the insurance server 103 according to an aspect of the disclosure. Broadly, the insurance server 103 comprises a communication module 201, a memory 202, and a processor 203.

The communication module 201 is configured to interface with various entities present in the system 100 such as the network 104, and the vehicle servers 106. The communication module may receive and send communications from another member of the system 100 over wired or wireless channel depending on the configuration and function performed within the context of the system 100.

The memory 202 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

The processor 203 is configured for executing instructions. Instructions may be stored in the memory 202, for example. The processor 203 may include one or more processing units (e.g., in a multi-core configuration) for executing instructions. The instructions may be executed within a variety of different operating systems on the insurance server 103, such as UNIX, LINUX, Microsoft Windows®, etc. More specifically, the instructions may cause various data manipulations on data stored in the memory 202 (e.g., create, read, update, and delete procedures). It should also be appreciated that upon initiation of a computer-implemented method, various instructions may be executed during initialization. Some operations may be required in order to perform one or more methods described herein, while other operations may be more general and/or specific to a particular programming language (e.g., C, C#, C++, Java, Javascript or other suitable programming languages, etc.).

The processor 203, in the present example, includes a distance processing module 204, a risk assessment module 205, a pricing module 206, and a charging module 207. The distance processing module 204 is configured to process or calculate the total distance travelled by the vehicle 102 over the course of a journey for which the insurance charge needs to be computed. In the present example, the insurance server 103 receives odometer data of the vehicle 102 from the vehicle server 106-1, which obtains it directly from the vehicle 102. Alternatively, it may be possible for the insurance server 103 to directly obtain the odometer data from the vehicle 102 via a device which can act as an interface between the odometer or an electronic control unit of the vehicle 102 and the insurance server 103. The distance processing module 204 may process a number of readings obtained from the odometer, either periodically or after every stop made throughout the journey. For example, at the start of the journey, a first reading of the odometer may be received, then at set time intervals, a new reading is received from the odometer. The distance processing module 204 then calculates the total distance travelled on the journey by processing all of the received readings. As the readings are received at various points throughout the journey, if the driver 101 manipulates or interferes with the odometer, the interference will be detected in the readings. Moreover, as the data is monitored in real-time by the vehicle server 106-1, the confidence in obtained readings is higher.

The risk assessment module 205 is configured to assess the risk of a journey based on a number of factors. The insurance server 103 receives sensor data from the vehicle server 106-1, which obtains this data from a plurality of sensors disposed on the vehicle 102. The risk of a journey may be increased or lowered based on the performance and upkeep, driving route and time of day, and driving style of the vehicle 102. Therefore, taking into account such parameters when calculating the insurance charge is understandably advantageous. In the present example, depending on the model of the vehicle 102, the vehicle server 106-1 obtains information about various components of the vehicle 102 and their real-time performance as affected by the driving style of the driver 101 or an autonomous driving function of the vehicle 102. One such piece of information is, for example, pressure on brake and accelerator pedals. If the driver 101 is exerting too much pressure on these pedals in the journey, it may indicate that the vehicle 102 is being driven aggressively which increases the risk of the journey. On the other hand, if the data received from speed and RPM sensors indicates that the speed is constantly within the prescribed limit, it may indicate that the driver 101 is adhering to the rules and has a good control on the vehicle. This may thus reduce the risk of the journey. Other such data influenced by the driver 101 or an autonomous function of the vehicle 102 that may be obtained from the sensors on the vehicle 102 include information relating to anti-lock braking, traction control, windscreen wiper, fog light, headlight, indicator lights, seat belt buckle status, audio/video system, windows, convertible/panoramic roof state, ignition state, and gear operation.

Other factors such as number of passengers in the vehicle may also be taken into account by the risk assessment module 205. More passengers may indicate heightened risk, which considerably increases if some or all of the passengers are not wearing their seat belts as detected by seat belt buckle sensors. Moreover, travelling long distances with young children, which may be indicated with the presence of a child in a child seat attached to the backseat, may also be taken into account in risk assessment.

There are several other factors which may not be directly influenced by the driver 101 but generally affect the performance of the vehicle 102. Such factors include fuel level, fuel consumption, outside temperature, inside temperature, tire pressure, engine oil level, engine oil pressure, airbags, washer fluid level, outside precipitation, vehicle battery level, time of the day, and GPS position of the vehicle. For example, driving in heavy rain or dense fog understandably increases the risk of the journey. However, this risk may be lowered if it is determined that the vehicle 102 is being driven more slowly, windscreen wipers are operational, fog lights are switched on, etc.

Another factor which is preferably taken into account for risk assessment is the software version of the vehicle 102. As most cars these days are equipped with modern electronics, many components of the car work with an associated program that defines their operation. These components can then also be re-programmed by a software upgrade to further enhance their performance. One such software upgrade could, for example, re-programme the ABS (Anti-lock Braking System) software on the vehicle 102 to reduce its stopping distance, thereby reducing the risk of the journey. In the present example, the vehicle 102 is configured to receive such software upgrade from its manufacturer via the vehicle server 106-1. It is preferred to operate the vehicle 102 updated with the latest software version. Therefore, the insurance server 103 also receives the software version of the vehicle 102 from the vehicle server 106-1 and the risk assessment module 205 factors that in when assessing the risk of the journey.

The risk assessment module 205 preferably uses an algorithm to calculate a risk score for a journey based on the various factors discussed above. It is to be understood that the risk assessment module 205 may not use all data received from the vehicle server 106-1 in calculating the risk score. For example, if the vehicle 102 is a rental car, the driver 101 may not be penalised for issues such as engine oil level, engine oil pressure, washer fluid level, etc. which are not expected to be managed by the driver 101 driving the rental car.

The following example shows calculation of a risk score based on a few factors taken into account during a journey made by the driver 101 using his own car 102. It is to be understood that the following example is not definitive and there may be other ways of calculating the risk score. Moreover, the risk score may be influenced by factors other than those considered in this example.

| | | Risk score | Weight | |
|---|---|---|---|---|
| | | (1-low to | of | Explanatory |
| Factors | State/Value | 5-high) | score | comments |
| No. of passengers | 4 | 2 | 0.4 | Increased risk |
| | | | | (more passengers) |
| Seat-belt status | Intact | 1 | 0.7 | Lowered risk (reduced |
| | throughout | | | likelihood of injury) |
| | the journey | | | |
| Maximum speed | 65 Mph | 1 | 0.8 | Lowered risk |
| | | | | (within the speed limit) |
| Misuse or | Twice | 2 | 0.4 | Increased risk (may |
| overuse of | | | | confuse other road users) |
| indicator lights | | | | |
| Outside | 5° C. | 1 | 0.3 | Lowered risk (cold |
| temperature | | | | but not freezing) |
| Inside | 15° C. | 2 | 0.2 | Increased risk (not |
| temperature | | | | ideal inside temperature) |
| Software version | v2.4 | 1 | 0.5 | Lowered risk (latest |
| of car | | | | version of software) |

| | |
|---|---|
| Overall risk score (weighted | 1.3 |
| average of risk scores) | |

The pricing module 206 is configured to receive inputs from the distance processing module 204 and the risk assessment module 205 to calculate the total price or charges for insurance for the journey. In the present example, the pricing module 206 receives the total distance as computed by the distance processing module 204 and the risk score as computed by the risk assessment module 205. The pricing module 206 then preferably uses an algorithm to calculate the insurance charges for the journey based on the received data and other set parameters. The following example illustrates one possible way of calculating the insurance price for the journey.

Total distance travelled—150 miles

Risk score—1.3

Base rate (per-mile rate)—$0.50

Journey insurance price—150*1.3*$0.50=$97.50

It is to be noted that the above base rate may be personalised based on other factors associated with the driver 101 such as his or her age, driving history, period of time with the insurance provider, etc.

The charging module 207 is configured to calculate a finalised insurance premium and prepare an invoice for the driver 101. In the present example, the insurance provider may charge the customer on monthly basis. In this case, the charging module 207 obtains the insurance charges for each journey made by the driver 101 in that month from the pricing module 206 to calculate the monthly premium. Therefore, for the month in which the driver 101 made none or very few short trips, the monthly premium is expected to be quite low. The charging module 207 may add a share of annual fixed cost to the monthly premium. The annual fixed cost is a set amount which the insurance provider may charge to cover for the vehicle 101 when it is parked or not in use for extended period of time. This annual cost may be spread over 12 months for the benefit of the customer. Following is an example of monthly premium calculation done by the charging module 207.

Total journeys taken in the month—8

Total cost of all the journeys in the month—$220

Annual fixed cost monthly split—$10

Total monthly premium—$230

The charging module 207 may generate an invoice with the total monthly premium and send it to the driver 101 preferably via the user App 105 or via email or post. The invoice is preferably accompanied by a detailed summary of charges for the sake of transparency. The user App 105 may be configured to process payment for the monthly premium from the driver 101 via an electronic wallet in the personal computing device. The charging module 207 may also be configured to process the payment and update the customer account. The driver 101 may instead set-up monthly direct debit or continuous payment authority (CPA) with the insurance provider and the charging module 207 accordingly processes the payment directly with an issuing bank or credit/debit card provider of the driver 101 without needing the driver 101 to actively pay each month.

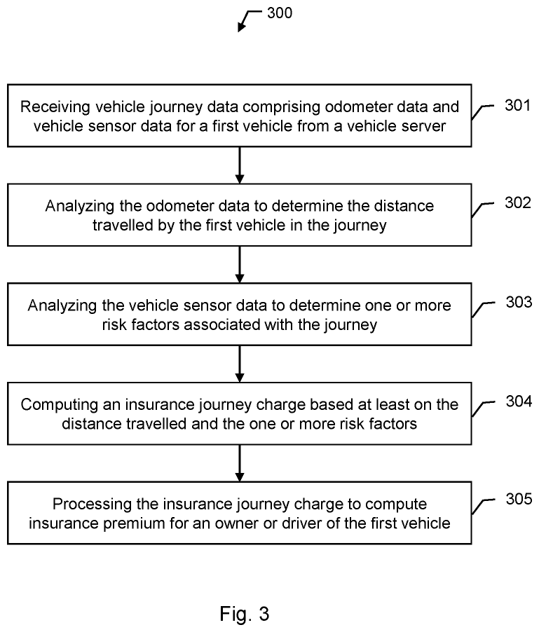

FIG. 3 shows a process 300 for computing insurance charges for a customer. It is to be noted that not all steps are shown in the process 300 and the sequence of steps may be altered in some embodiments. Moreover, the steps may be performed by multiple entities in the system 100, which may or may not be shown.

At step 301, vehicle journey data comprising odometer data and vehicle sensor data for a first vehicle is received from a vehicle server. In the present example, the insurance server 103 seeks permission from the driver 101 of the vehicle 102 to request vehicle journey data from the vehicle server 106-1. The insurance server 103 may send a permission request to the driver 101 preferably via the user App 105 or via SMS or email. The driver 101 then may grant the permission to the vehicle server 106-1. After receiving the driver's permission, the insurance server 103 connects to the vehicle server 106-1 directly or via the intermediary 107 to access the odometer data and the vehicle sensor data for a given journey.

At step 302, the odometer data is analyzed to determine the distance travelled by the first vehicle in the journey. In the present example, after receiving the odometer data, the distance processing module 204 analyzes and processes the odometer data received from the vehicle server 106-1 to calculate the total distance travelled by the vehicle 102 in the journey. As the data is directly received from the vehicle server 106-1 and contains readings obtained in real-time, the sanctity of data is maintained.

At step 303, the vehicle sensor data is analyzed to determine one or more risk factors associated with the journey. In the present example, after receiving the sensor data, the risk assessment module 205 analyzes the sensor data to determine risks associated with the taken journey. As explained above, the risk assessment module 205 calculates a risk score for the journey based on a number of factors assessed using the sensor data. The risk score is indicative of the level of risk involved in the journey taken by the driver 101 using the vehicle 102.

At step 304, an insurance journey charge is calculated based at least on the distance travelled and the one or more risk factors. In the present example, the distance processing module 204 and the risk assessment module 205 feeds in the calculated journey distance and the risk score into the pricing module 206. The pricing module 206 then calculates the total insurance charge for the journey based on the received data and other parameters such as the base rate per mile.

At step 305, the insurance journey charge is processed to compute an insurance premium for an owner or driver of the first vehicle. In the present example, the charging module 207 calculates a monthly insurance premium to be paid by the driver 101 (or owner) of the vehicle 102 to the insurance provider. The insurance premium includes the insurance journey charge for each journey made with the vehicle 102 during that month as well as a portion of the annual cost. The charging module 207 also prepares a statement and processes the payment received from the driver 101.

As described above, using the above described system and method, it is possible to compute insurance charges more fairly and accurately. The customer is not obliged to pay a hefty price every month when he or she did not take many trips and/or followed all driving rules and maintained the vehicle well. As for the insurance provider, it can be assured of charging the right premium for long and risky journeys and not losing money by basing the charges on potentially incorrect data received from tampered odometer or otherwise.

Having described aspects of the disclosure in detail, it will be apparent that modifications and variations are possible without departing from the scope of aspects of the disclosure as defined in the appended claims. As various changes could be made in the above constructions, products, and methods without, departing from the scope of aspects of the disclosure, it is intended that all matter contained in the above description and shown in the accompanying drawings shall be interpreted as illustrative and not in a limiting sense.

As will be appreciated based on the foregoing specification, the above-described embodiments of the disclosure may be implemented using computer programming or engineering techniques including computer software, firmware, hardware or any combination or subset thereof.

While the disclosure has been described in terms of various specific embodiments, those skilled in the art will recognize that the disclosure can be practiced with modification within the scope of the claims.

What is claimed is:

1. A system for determining a motor vehicle insurance charge for a journey, the system comprising an insurance provider server in communication with at least one vehicle server configured to store vehicle journey data received from a first vehicle, wherein the insurance provider server comprises:
a memory;
a communication module for receiving the vehicle journey data for the first vehicle from the at least one vehicle server, the vehicle journey data comprising odometer data and vehicle sensor data acquired by the at least one vehicle server from one or more sensors on the first vehicle over the course of the journey;
a distance processing module for analyzing the received odometer data to determine the distance travelled by the first vehicle in the journey;
a risk processing module for analyzing the vehicle sensor data to determine one or more risk factors associated with the journey;
a pricing module for computing an insurance charge based at least on the distance travelled and the one or more risk factors for the journey; and
a charging module for processing the insurance charge for one or more journeys to compute an insurance premium and collect payment from an owner or driver of the first vehicle.

2. The system of claim 1, wherein the communication module further receives a vehicle software version from the vehicle server, the vehicle software version being indicative of performance of one or more components of the first vehicle.

3. The system of claim 2, wherein the insurance charge is further based on the vehicle software version.

4. The system of claim 1, where the one or more sensors on the first vehicle collect information relating to one or more of fuel level, fuel/energy consumption, outside temperature, inside temperature, tire pressure, engine oil level, engine oil pressure, anti-lock braking, traction control, stability control, cruise control, airbags, washer fluid level, windscreen wiper, audio/video system, outside precipitation, fog light, headlight, number of passengers, seat belt buckle status, speed, RPM, indicator lights, pressure on brake and accelerator pedals, windows, convertible/panoramic roof state, vehicle battery level, maintenance data, fault codes, ignition state, autonomous driving state, gear data, time of the day, and GPS position of the first vehicle.

5. The system of claim 1, wherein the insurance provider server is configured to obtain a permission from the owner or driver of the first vehicle to receive the vehicle journey data from the at least one vehicle server.

6. The system of claim 5, wherein the insurance provider server is configured to obtain the permission from the owner or driver of the first vehicle using a mobile application.

7. The system of claim 1, wherein the insurance provider server is configured to receive the vehicle journey data from the at least one vehicle server via an intermediary.

8. The system of claim 7, wherein the intermediary is configured to collate data from vehicle servers of a plurality of vehicle manufacturers in a standardized format.

9. The system of claim 7, wherein the intermediary is configured to receive the vehicle journey data at periodic intervals.

10. The system of claim 8, wherein the vehicle servers are configured to send the vehicle journey data to the intermediary immediately after processing the odometer data and the sensor data received from one or more vehicles.

11. A computer-implemented method of determining a motor vehicle insurance charge for a journey, comprising the steps of:
receiving vehicle journey data for a first vehicle from at least one vehicle server, the vehicle journey data comprising odometer data and vehicle sensor data acquired by the at least one vehicle server from one or more sensors on the first vehicle over the course of the journey;
analyzing the received odometer data to determine the distance travelled by the first vehicle in the journey;
analyzing the vehicle sensor data to determine one or more risk factors associated with the journey;
computing an insurance charge based at least on the distance travelled and the one or more risk factors for the journey; and
processing the insurance charge for one or more journeys to compute an insurance premium and to collect payment for the one or more journeys.

12. The method of claim 11, further comprising receiving a vehicle software version from the vehicle server, the vehicle software version being indicative of the performance of one or more components of the vehicle.

13. The method of claim 12, further comprising computing the insurance charge based on the vehicle software version.

14. The method of claim 11, further comprising receiving the vehicle journey data through an intermediary which is connected to a plurality of vehicle servers operated by respective plurality of vehicle manufacturers.

15. The method of claim 14, further comprising collating the vehicle journey data in a standardized format by the intermediary before sending it to an insurance provider server.
